(19) United States
(12) Patent Application Publication
(10) Pub. No.: US 2017/0249453 A1
(43) Pub. Date: Aug. 31, 2017

(54) CONTROLLING ACCESS TO SECURED MEDIA CONTENT

(71) Applicant: HEWLETT PACKARD ENTERPRISE DEVELOPMENT LP, Houston, TX (US)

(72) Inventors: Douglas L. VOIGT, Boise, ID (US); Paul KALER, Houston, TX (US)

(73) Assignee: HEWLETT PACKARD ENTERPRISE DEVELOPMENT LP, Houston, TX (US)

(21) Appl. No.: 15/500,031

(22) PCT Filed: Oct. 13, 2014
(86) PCT No.: PCT/US2014/060275

§ 371 Date: Jan. 28, 2017

(51) Int. Cl. G06F 21/35; G06F 3/06; G06F 21/62

(52) U.S. Cl. CPC G06F 21/35; G06F 21/6218; G06F 3/0622; G06F 3/0659; G06F 3/067

(57) ABSTRACT

A technique includes controlling access to secured media content. The access control includes, in response to a principal attempting to access secured media content, challenging authentication of the principal to access the secured media. Challenging the authentication includes launching an authentication agent in response to the content of an electronic label associated with the secured media content and using the authentication agent to provide a result indicating whether the principal has permission to access the secured media content. The technique includes based on the result, selectively allowing the principal to access the secured media content.

### BACKGROUND

A computer system has traditionally contained both volatile and non-volatile storage devices. In this manner, due to their relatively faster access times, volatile memory devices, such as dynamic random access memory (DRAM) devices, have traditionally been used to form the working memory for the computer system. To preserve computer system data when the system is powered off, data has traditionally been stored in non-volatile mass storage devices associated with slower access times, such as magnetic media-based or optical media-based mass storage devices.

The development of relatively high density, solid state non-volatile memory technologies with relatively fast access times is closing the gap between the two technologies; and as a result, non-volatile memory devices are increasingly being used to form working, persistent memory for both traditional “memory” and “storage” functions. Due to the proliferation of non-volatile memory devices, an increasing amount of data may be “permanently” preserved in non-volatile storage.

### BRIEF DESCRIPTION OF THE DRAWINGS

FIG. 1 is a schematic diagram of a computer system according to an example implementation.

FIG. 2 is an illustration of the contents of an electronic label of a media container of FIG. 1 according to an example implementation.

FIGS. 3 and 4 are flow diagrams depicting techniques to challenge and authenticate access rights to secured media content according to example implementations.

FIG. 5 is an illustration of authentication data used by an authentication service according to an example implementation.

FIGS. 6 and 7 are illustrations of systems to challenge and authenticate access rights to secured media content using direct communication with an access rights grantor according to example implementations.

FIG. 8 is a schematic diagram of a physical processor-based machine according to an example implementation.

### DETAILED DESCRIPTION

Due to increasing use of non-volatile memory storage in electronic devices, access-restricted media content may be “permanently” stored. As examples, this access-restricted media content may be content pertaining to trade secrets, human resource information, engineering designs, confidential memorandums, journal articles, subscription-based or paid access-based articles and so forth. Systems and techniques are disclosed herein to enforce and dynamically manage access rights to such media content, using information and machine executable instructions that are contained in an electronic label that is associated with the content. The media content may be a database file, a text document, a photographic image file, a video file, a portable document file (.pdf file), and so forth.

More specifically, in accordance with systems and techniques that are disclosed herein, the information that is contained in the electronic agent allows an access rights grantor for the media content to grant a given principal access to the media content in real time or by using an authorization service that has a pre-specified list of principals that are allowed to access the media content. In this context, “access rights grantor” refers to an entity that has the right to grant or deny access to the media content, such as an owner of the secured media or an entity that has rights to grant access, which may be publisher or distributor of the secured media content or a person who is otherwise designated the right to grant access rights. The “principal” refers to a human user of a machine who attempts to access the secured media content, a software entity, a hardware entity, and so forth.

As a specific example, the access rights grantor may be an individual who creates media content (a video, word processor-based document, a photograph, and so forth) and desires to limit access to the media content, using the systems and techniques that are disclosed herein

In accordance with example implementations, access to the media content is controlled using an authentication agent that accompanies the media content. In this manner, the media content may be contained within a media container (a flash drive, a file, and so forth) that also contains the electronic label; and the electronic label and media content are separate, identifiable parts of the media container. The media content is “secured,” in the media container to prevent unintended access. For example, the media content may be encrypted to produce corresponding secured media content that is stored in the media container. The electronic label contains machine executable instructions (i.e., “software”), which, when executed, launch the authentication agent, and the authentication agent initiates a process to determine whether a given principal that is attempting to access the secured media content has permission for this access. The permission may be granted in real time by the access rights grantor for the secured media content or may be granted based on pre-specified permissions from the grantor, as described further herein.

In accordance with example implementations, in addition to the machine executable instructions for the authentication agent; the electronic label contains an encrypted media identifier that identifies the secured media content; and a digitally-signed reference to an authentication service or application. When a given principal attempts to access the secured media content, the authentication agent communicates data representing a hash of the encrypted media identifier and the principal's identity to either the access rights grantor or to an authentication service that acts on behalf of the access rights grantor.

If the authentication service is used and the access rights grantor, through pre-specified permissions, has indicated that the principal is to be allowed access to the secured media content, then the authentication service provides a key to the authentication agent, which allows the principal to access the secured media content. If real time communication with the access rights grantor is used to obtain permission, the access rights grantor has the opportunity to enable or deny access based on the principal's identity (which may or may not be encrypted, depending on the particular implementation).

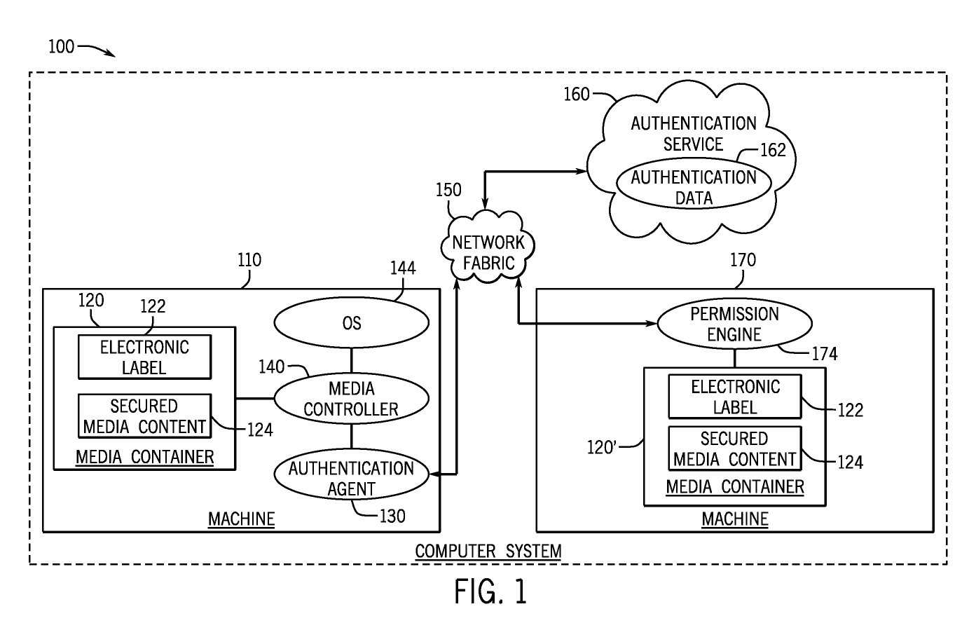

Referring to FIG. 1, as a more specific example, a machine 110 of a computer system 100 performs the following actions in response to a principal attempting to access secured media content 124. In particular, these actions involving challenging and authenticating the right or permission of the principal to access the secured media content 124; and upon successful authentication, the actions include unsecuring the content 124 to allow access by the principal.

As depicted in FIG. 1, the secured media content 124 is part of a media container 120. As an example, the media container 120 may be a removable media package, such as a removable media memory drive device (a flash drive, for example) a removable solid state drive, removable optical disc media, and so forth, which is read by a corresponding drive (not shown) of the machine 110.

In further example implementations, the media container 120 may not be part of a removable package but may be a unit of digital media (a file, for example) that may be delivered to the machine 110 via a download from the Internet, arrive as an attachment to an electronic mail (email), and so forth. Thus, the media container 120 may take on numerous forms and may be delivered in numerous different ways, depending on the specific implementation. Regardless of its particular form, the media container 120 contains the secured media content 124 and an electronic label 122.

In accordance with example implementations, the secured media content 124 is encrypted to protect the underlying data from being accessed by an unauthorized principal. As described herein, the electronic label 122 contains unencrypted data and machine executable instructions (or “software” or “program code”) that launch an authentication agent 130 to challenge and authenticate the right of a principal to access secured media content 124.

For the example implementation depicted in FIG. 1, an authentication service 160 is used for purposes of authenticating the access rights of the principal. As an example, the authentication service 160 may be an Internet-based and/or cloud-based service that is accessed via corresponding local or global network fabric 150, in accordance with example implementations.

The permission for a particular principal to access given secured media content 124 is controlled by the access rights grantor for the secured media content 124. In accordance with example implementations, the access rights grantor may register with the authentication service 160 (out of possibly many available authentication services); and as a result of this registration, the access rights grantor may obtain a Uniform Resource Locator (URL) address for the authentication service 160 and obtain machine executable instructions or image from the service 160, which correspond to the authentication agent 130. It is noted that there may be many cloud authentication services with different URL addresses. Although it is described herein as an exhaustive list of media/principal pairs, the permutation of media and principals may take any of a number of forms, including groupings of media and principals that are selectively paired.

The access rights grantor may create a given media container 120 using a permission application, as represented by a permission engine 124 that executes on a machine 170 in FIG. 1 to produce a media container 120′ (where the reference numeral “120′” is used to denote the prior creation of the media container 120 before being introduced to the machine 110). In accordance with example implementations, the permission engine 124 communicates with the authentication service 160, under the direction of the access rights grantor, to create authentication data 162. As further described herein, the authentication data 162 may describe identities of various secured media associated with access rights grantors, the principals that are authorized to access this media, specific access rights for these principals.

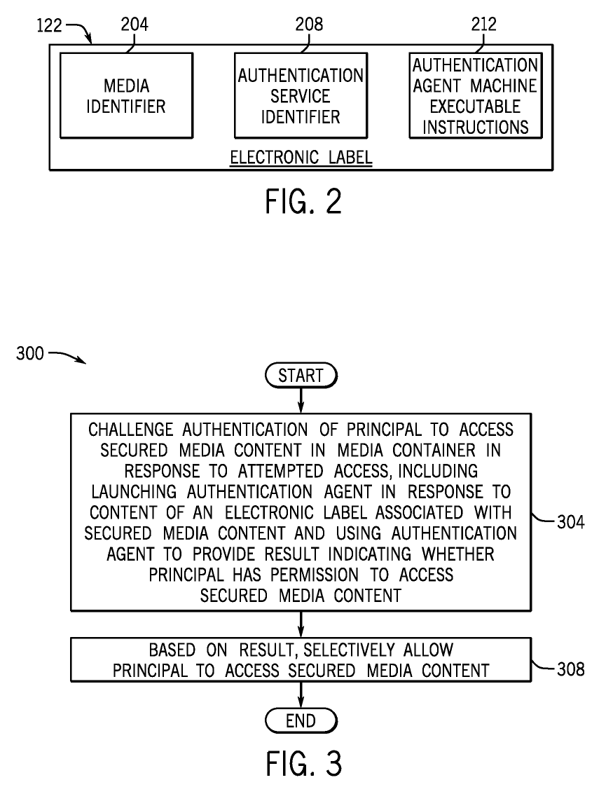

In accordance with example implementations, to create the media container 120′, the access rights holder identifies media content to be protected to the permission engine 174. The permission engine 174 then encrypts the media to produce the secured media content 124, and the permission engine 174 creates the electronic label 122. Referring to FIG. 2 in conjunction with FIG. 1, in accordance with example implementations, the electronic label 122 includes a media identifier 204, which may be encrypted and which is used by the authentication service 160 or access rights grantor to identify the secured media content 124; an authentication service identifier 208 (the URL address of the authentication service 160, for example); and authentication agent machine executable instructions 212 (or image), which, when executed, forms the authentication agent 130.

It is noted that in accordance with example implementations, after registration with the authentication service 160 and creation of the media container 120′, the access rights grantor may no longer use the permission engine 174 or interact with the authentication service 160, except perhaps for updating principal access rights, as further described herein.

Referring back to FIG. 1, when the machine 110 discovers the media container 120, the machine 110 may take the following actions, in accordance with example implementations. First, a media controller 140 of the machine 110 recognizes the protected state the media container 120. As an example, the media container 120 may be discovered in response to a principal, or user, “clicking” a mouse pointer on a given file (i.e., the container 120), inserting a flash drive device into a universal serial bus (USB) port (i.e., where the memory container 120 is a flash drive), and so forth.

In response to the attempted access, the media controller 140 recognizes the protected state of the secured media 124 and in accordance with some example implementations, informs an operating system 144 of the protected state. The media controller 140 accesses the electronic label 122 for purposes of obtaining the media identifier 204, authentication service identifier 208 and the authentication agent instructions 212. The media controller 140 then causes the instructions 212 to be executed to launch the authentication agent 130.

Using the authentication service identifier 208, the authentication agent 130 contacts the authentication service 160 for purposes of determining whether a principal identity associated with the attempted access is authorized to access the secured media content 124. As an example, the authentication agent 130 may use a login identification (ID) as a principal identifier, may cause a message to be displayed prompting a user to enter an identification that serves as the principal identity, and so forth.

More specifically, in accordance with example implementations, the first time that a principal attempts to access the media container 120, the principal may enter identity information that the access rights grantor will recognize, such as, for example, an email address of the principal. In accordance with some implementations, the authentication service 160 may add security by sending a one time use code to the principal via the email address. By accessing the one time use code, the principal causes an encrypted or hashed form of the principal's identity to be communicated to the authentication agent for ongoing use. This is the same hashed or encrypted identity that was, or will be, entered into the authentication service 160 as a result of the access rights grantor's designation of the principal as one who is allowed to access the secured media content.

In accordance with example implementations, when the OS 144 of the machine 110 recognizes that the special device or file type associated with the media container 120, the OS 144 triggers installation of the authentication agent 130. The authentication agent 130 may be digitally signed by the authentication service 160 so that a chain of trust is established between the principal and the access rights grantor. The authentication agent 130 may then be read from the media container 120 while in the restricted mode using the media controller 140.

The authentication agent 130 communicates the media and principal identities to the authorization service 160; and based on the media and principal identities, the authorization service 160 authorizes or does not authorize access to the secured media content 120. The media controller 140 then responds accordingly to allow/not allow the principal to access the secured media content 124.

Thus, referring to FIG. 3, in accordance with example implementations, a technique 300 includes challenging (block 304) authentication of a principal to access secured media content in a media container in response to an attempted access, where the challenging includes launching an authentication agent in response to a content of an electronic label associated with the secured media content and using the authentication agent to provide a result indicating whether the principal has permission to access the secured media content. Based on the result, the principal is selectively allowed to selectively access the secured media content based on the result, pursuant to block 308.

Referring back to FIG. 1, as more specific examples, in accordance with example implementations, the machine 110 may be a virtual machine (VM) (a guest VM executing on a physical, processor-based platform, for example) or may be a physical processor-based platform, depending on the particular implementation. The media controller 140, in accordance with example implementations, may be a software driver, other software component, or may, in general, be hardware, which allows the machine 110 to access media.

When the media controller 140 first opens or accesses the media container 120, the media controller 140 recognizes the content 124 as being secured and places the media container 120 in a restricted mode, which permits the electronic label 122 to be read but does not allow the secured media content 124 as well as potentially other secured parts of the container 120 to be read. In this manner, the secured parts of the media container 120, in accordance with example implementations, are locked until an encrypted key is delivered to the media controller 140. Upon delivery of the encrypted key, the media controller 140 reclassifies the media container 120 to place the container 120 in an unsecure, “normal” mode to allow the principal to access the content 124.

In accordance with example implementations, if the media controller 140 detects power loss or removal of the media container 120 or attempted access by another principal, the media controller 140 reclassifies the media container 120 as being in the restricted mode, such that the challenge and authentication process reports when access to the media container 120 occurs.

In accordance with example implementations, the authentication service 160 provides pre-authorization capability so that the access rights grantor of the secured media content 124 is not burdened with the computation or connectivity requirements of pre-approved authentication challenges. This pre-authentication capability is based on the content of the authentication data 162.

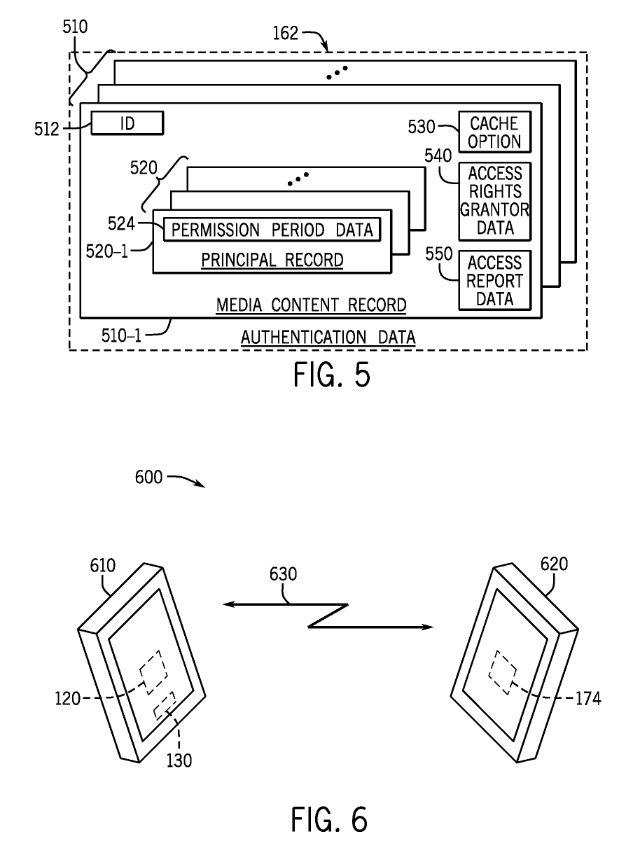

Referring to FIG. 5 in conjunction with FIG. 1, in accordance with example implementations, the authentication data 162 may contain the following information. It is noted that the data organization that is depicted in FIG. 5 is merely for purposes of illustrating some of the information that may be part of the data 162, as the data 162 may have other organizations, in accordance with further example implementations.

The authentication data 162, for the example implementation that is depicted in FIG. 5, includes media content records 510, such as example media content record 510-1. In general, the media content record 510 for each unit of secured media content 124 is created for a corresponding identification (ID) 512 that corresponds to the unit. As illustrated for the media content record 510-1, the media content record 510 contains principal records 520 (principal record 520-1 being specifically illustrated), which contains information for each principal that is authorized to access the secured media.

As shown in FIG. 5, the principal record 520 may contain data 524, which establishes a permission period for the associated principal, such that access by the principal may be restricted by a date and/or time. The media content record 510 may further include data 540 identifying the access rights grantor for the secured data and data 550, which indicates whether or not the grantor wants to be notified when a new principal first attempts to access a given piece of media. In this manner, the access rights grantor may be elected to be notified when access permission is granted, denied, or both. Moreover, notifications may be delivered individually to the access rights grantor in real time or simply logged and reported at a later time. Thus, many variations are contemplated, which are within the scope of the appended claims.

As also depicted in FIG. 5, the media content record 510 may contain data 530 indicating a cacheable option. In general, the cacheable option indicates whether or not a machine, which accesses the secured media may cache permission for a particular principal, thereby circumventing repetitive challenges.

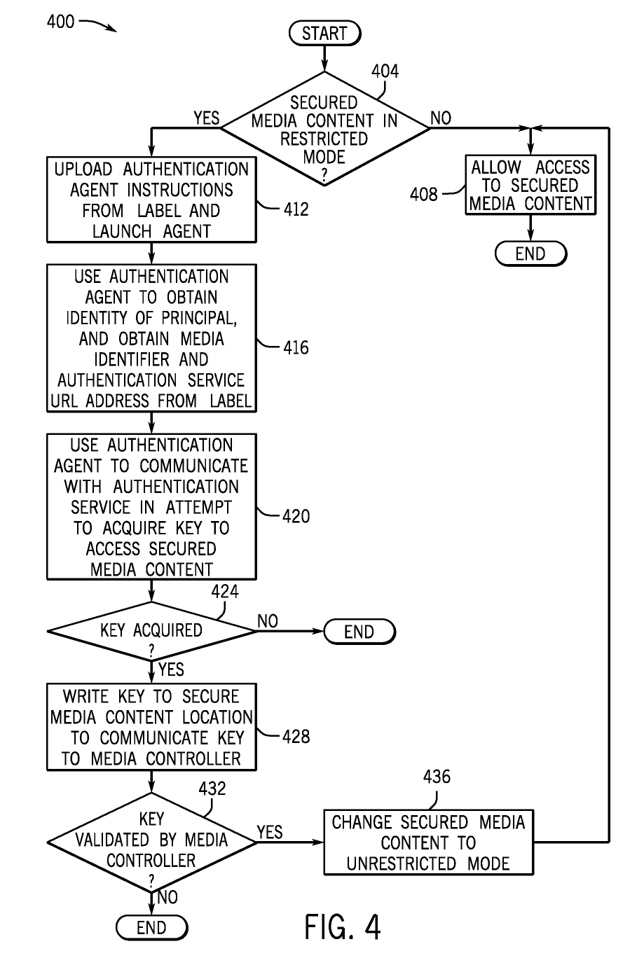

Thus, referring to FIG. 4 in conjunction with FIG. 1, in accordance with example implementations, a technique 400 may be performed by the machine 110 for purposes of challenging and authenticating the right of a principal to access secured media content. Technique 400 begins when a principal attempts to access the content of a secured media container. The technique 400 includes determining (decision block 404) whether the secured media container is in a restricted mode, which is the default mode for the media container for the principal's initial access. If not, the media controller allows (block 408) access to the media of the media container.

Otherwise, if the media container 120 is in the restricted mode, the media controller uploads authentication agent instructions from the label of the container and launches the authentication agent, pursuant to block 412. In accordance with example implementations, the media controller may inform an OS as to the nature of the media container 120, the OS may trigger the uploading and launching of the authentication agent. The authentication agent is used to obtain an identity of the principal and obtain the media identifier and authentication service URL address from the label, pursuant to block 416. Moreover, the authentication agent is used (block 420) to communicate with the authentication service in an attempt to acquire a key to allow access to the secured media.

If the key is acquired (decision block 424), then the key is written (block 428) by the authentication agent to the media controller, which causes the media controller to validate the key. Otherwise, if the key is not acquired (decision block 424), then the media container 120 remains in the restricted mode. If the key is validated (decision block 432) by the media controller, then the media controller changes the mode of the media container to being an unrestricted mode, pursuant to block 436, thereby allowing access to the media of the media container (block 408). Otherwise, if the key is not validated (decision block 432) by the media controller, then the media container remains in the restricted mode.

Referring to FIG. 2 in conjunction with FIG. 1, in accordance with example implementations, in the creation of the media container 120′, the permission engine 174 accesses the electronic label 122 and populates the label 122 with a unique media identity that is created by the permission engine 174. The unique identity of the memory container 120′ is derived using such techniques as combining a unique identity of the access rights grantor with a unique number allocated by the access rights grantor, as an example.

The permission engine 174 may write additional fields to the label 122′ in accordance with the information received from the authentication service 160 during registration with the service 160. As an example, this information may include a shared secret, which is not visible as part of the label 122 but is used by the media controller as part of authorization decryption.

In accordance with example implementations, after the authentication agent 130 is launched (i.e., running), the authentication agent 130 reads the media identifier from the electronic label 122, hashes the media identity with the principal identity and transmits the result to the authentication service 160. The authentication service 160 may then locate the hash in its permission table (identify one of the principal records 520 of FIG. 5, for example); determines what permissions (if any) are allowed for the principal and the secured media; and return an encrypted authorization key to the authentication agent 130.

In accordance with example implementations, the encryption process may be modified by a piece of random information, which is read from the media controller 140 by the authentication agent 130 and communicated to the authentication service 160. The authentication agent 130 writes the authorization key to the media container 160, so as to enable media access. When the media controller 140 receives the encrypted key, in accordance with example implementations, the media controller 140 uses the random information it generated earlier along with the shared secret that flowed from the authentication service 160 to the access rights grantor when the media was initialized in the key decryption process. If the decrypted authorization key is valid, then access to media content is enabled.

In accordance with further example implementations, a principal may desire to obtain permission to access secure media when the authentication service 160 is not accessible. This may be accomplished using such techniques as email, instant messaging or text messaging (i.e., short message service (SMS) messaging) of the access rights grantor.

Using this scheme, the above-described challenge and authentication processes may be modified as follows. Instead of accessing the authentication service 160, the authentication agent 130 communicates a message (via an email or text message, for example), directly to the access rights grantor. This message may include the name of the principal in human recognizable form. If the access rights grantor opts to give permission to the principal, then a designated part of the message may be copied and pasted into the access rights grantor's permission engine 174. The permission engine 174 then generates an encrypted response, which is copied and pasted back into a return message to the principal and in turn, is copied into the authentication agent 130. The information conveyed in the copied and pasted message excerpts is the same as the information that would have been conveyed between the authentication agent 130 and the authentication service 160, in accordance with example implementations.

In accordance with further example implementations, a principal may know in advance of the need to access secured media content offline. In such situations, the principal may identify the media to the authentication agent 130, which interacts with the authentication service 160 or the access rights grantor in the same manner as it would if the media had been inserted. The authentication agent 130 may then cache the response so that when the corresponding media container 120 is subsequently discovered by the machine 110, the authorization code is already available to the machine 110.

In accordance with further example implementations, the machines 110 and 170 may be formed at least in part from respective portable devices, such as a smartphone, a tablet, a portable computer, and so forth. In this manner, FIG. 6 depicts an illustration 600 of a first portable device 610 that, for this example, is attempting to access secured media content stored in a media container 120 and communicates via a relatively short range, direct communication link 630 with another portable device 620, which for this example, is operated by the access rights grantor and contains a permission engine 174. The communication link 630 may be, as examples, an optical link, a radio frequency (RF) link (a Bluetooth link, for example), a direct Wi-Fi link, and so forth. Thus, many implementations are contemplated, which are within the scope of the appended claims.

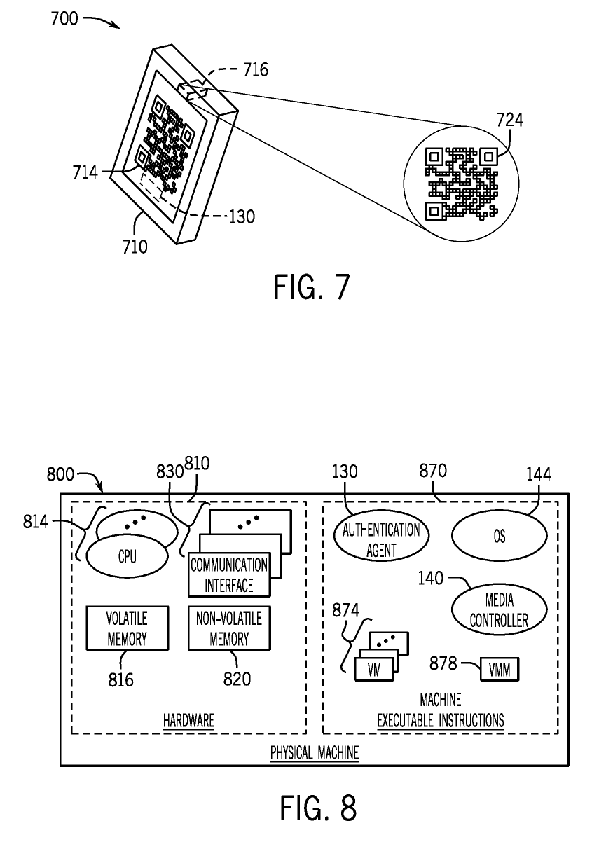

FIG. 7 depicts an illustration 700 of another way in which a given portable electronic device 710 may authenticate the right of a principal to access secured media using the device 710. For this example, authentication is accomplished using a visual recognition (VR) image 724. In this manner, the access rights grantor of secured media content may be in proximity to the principal so that a permission engine executing on the access rights grantor's portable electronic device (not shown) may display a VR image 724. In further example implementations, the access right grantor may display a physical tag that contains the VR image 724.

A camera 716 of the principal's portable electronic device 710 may then take a snapshot, or picture, of the VR image 724 (as depicted by image 714 on a display of the device 710), and upon recognition of the VR image 724, an authorization agent 130 executing on the device 710 gives the permission to the principal for access to the media content. In this manner, the authentication agent 130 receives and decrypts the corresponding VR code and writes the resulting encrypted authorization code (i.e., a key) to the secured media content; and the media controller of the portable electronic device 710 processes the authorization code, as described above. The same process may be used in any type of close proximity communication that ensures that the access rights grantor is aware in real time of the exchange of authorization information with any nearby principal.

In general, an authentication service may interact with the access rights grantor is several ways. If access for a principal is denied, the service may contact the access rights grantor by email or directly through the permission engine to enable access to the media content by the principal in real time. The access rights grantor may cause any or all permissions to access the secured media content to expire at any time for any reasons. Access that is denied or permitted may be logged and/or reported to the access rights grantor with optional records of the principal identifications (IDs), in accordance with example implementations.

Referring to FIG. 1, in accordance with example implementations, the machine 110 or 170 may be an actual physical machine or may be a virtual machine that executes on such an actual physical machine. Referring to FIG. 8, such an actual physical machine may include hardware 800 as well as machine executable instructions 870, or “software.”

Although the physical machine 800 is depicted in FIG. 8 as being contained within a corresponding box, the physical machine 800 may be a distributed machine, which has multiple nodes that provide a distributed and parallel processing system in accordance with example implementations. In accordance with example implementations, the physical machine 800 may be located within one cabinet (or rack); or alternatively, the physical machine 800 may be located in multiple cabinets (or racks).

The physical machine 800 may include such hardware 810 as one or more central processing units (CPUs) 814 and a memory that stores machine executable instructions, application data, configuration data and so forth. More specifically, the memory may include volatile memory 816 and non-volatile memory 820, in accordance with example implementations. In general, the memories 816 and 820 are formed from non-transitory storage devices, such as semiconductor devices, magnetic storage devices, memristors, phase change devices, optical storage devices, and so forth. In accordance with example implementations, the memory of the physical machine 800 stores instructions that are executed by the CPU(s) 814 for purposes of performing one or more parts of the techniques that are disclosed herein, such as techniques 300 and 400.

The physical machine 800 may include various other hardware components, such as one or multiple communication interfaces 830 (network interface cards, serial bus interfaces, and so forth) and one or more of the following: mass storage drives; a display; input devices, such as a mouse and a keyboard; removable media devices; and so forth.

The machine executable instructions, when executed by the CPU(s) 814, cause the CPU(s) 814 to form one or more components of the machine 110 (FIG. 1) or machine 170 (FIG. 1). For example, referring to FIG. 8 in conjunction with FIG. 1, when used as the platform for the machine 110, the machine executable instructions 870 may, when executed by the CPU(s) 814, form such components as the operating system 144, media controller 140 and authentication agent 130. In accordance with some implementations, the machine executable instructions 870 may, when executed by the CPU(s) 814, may form one or multiple virtual machines (VMs) 874, as well as a hypervisor, or virtual machine monitor (VMM) 878. In this manner, the machine 110 and/or 170 may be contained in a VM 874, in accordance with example implementations.

Other implementations are contemplated, which are within the scope of the appended claims. For implementations described above, the authentication agent is launched by executing machine executable instructions that are contained in the electronic label. In further example implementations, the authentication agent may be launched using other content of an electronic label. For example, in accordance with some implementations, the electronic label may contain data that represents an authentication agent identifier (an application name, for example), and machine executable instructions for the authentication agent may be downloaded (downloaded from an Internet server, for example) based on the authentication agent identifier. The downloaded, machine executable instructions may then be executed to complete launching of the authentication agent.

While the present techniques have been described with respect to a number of embodiments, it will be appreciated that numerous modifications and variations may be applicable therefrom. It is intended that the appended claims cover all such modifications and variations as fall within the scope of the present techniques.

What is claimed is:

1. A method comprising:
controlling access to secured media content, comprising:
in response to a principal attempting to access the secured media content, challenging authentication of the principal to access the secured media, wherein challenging the authentication comprises launching an authentication agent in response to content of an electronic label associated with the secured media content and using the authentication agent to provide a result indicating whether the principal has permission to access the secured media content; and
based on the result, selectively allowing the principal to access the secured media content.

2. The method of claim 1, wherein the label contains data representing a first identifier for the media content and representing a second identifier identifying an authentication service, and using the authentication agent comprises communicating representations of the first identifier and a third identifier identifying the principal to the authentication service.

3. The method of claim 1, wherein using the authentication agent comprises determining whether the principal has permission based on communication with a third party authentication service or communication with a device controlled by an access rights grantor for the secured media content.

4. The method of claim 1, wherein the principal is associated with a first electronic device and using the authentication agent comprises using the first electronic device to communicate with a second electronic device controlled by an access rights grantor of the secured media content to acquire permission to access the secured media content using a direct communication between the first and second electronic devices.

5. The method of claim 1, wherein launching the authentication agent comprises:
downloading machine executable instructions using an authentication agent identifier represented by data of the label and executing the downloaded machine executable instructions; or
executing machine executable instructions of the label.

6. The method of claim 1, wherein using the authentication agent comprises optically scanning a code controlled by a permission rights grantor for the secured media content.

7. The method of claim 1, wherein using the authentication agent comprises communicating with a global network service identified by the content of the label or communicating with a permissions application associated with a permission rights grantor for the secured media content.

8. An apparatus comprising:
a memory storing media content to be protected; and
a processor to generate a label to accompany the media content to control access to the media content, the processor to:
register a first identifier for the media content with an authentication service;
store the first identifier in a label of a container that contains the media content; and
store content in the label, the content being used to launch an authorization agent that provides a result indicating whether a principal has permission to access the secured media content.

9. The apparatus of claim 8, wherein the processor communicates data representing an identity of at least one principal authorized to access the media content to the authorization service.

10. The apparatus of claim 8, wherein the processor discloses an attempted access by a principal to the media content, and the processor selectively bypasses authorization by the authorization service.

11. The apparatus of claim 8, wherein the processor communicates time duration data to the authentication service, the time duration information identifying a time duration for which an associated principal is authorized to access the media content.

12. The apparatus of claim 8, wherein the processor communicates an indication to the authentication service whether the access rights grantor wants to be contacted when a given principal first attempts to access the media content.

13. An article comprising a non-transitory computer readable storage medium to store instructions that when executed by a processor-based machine cause the processor-based machine to:
in response to an attempted access to secured media content by a principal, selectively classify the secured media content as belonging to a restricted type to prevent the access and use the content of an electronic label associated with the unsecured media content to launch an authentication agent to authenticate whether the principal has permission to access the secured media content; and
in response to the authentication agent providing a key associated with authorization of the principal to access the secured media content, selectively reclassify the secured media content from belonging to the restricted type to belonging to an unrestricted type to allow the principal to access the secured media content.

14. The article of claim 13, the storage medium storing instructions that when executed by the processor-based machine cause the processor-based machine to write the key to a location of the secured media content to cause a media controller to selective reclassify the secured media content.

15. The article of claim 13, the storage medium storing instructions that when executed by the processor-based machine cause the processor-based machine to reclassify the secured media content from belonging to the unrestricted type to belonging to the restricted type in response to detecting a power loss or removal of a media container containing the secured media content.
